(19) United States
(12) Patent Application Publication
(10) Pub. No.: US 2020/0409394 A1
(43) Pub. Date: Dec. 31, 2020

(54) UNMANNED AERIAL VEHICLE CONTROL METHOD AND DEVICE, UNMANNED AERIAL VEHICLE, SYSTEM, AND STORAGE MEDIUM

(71) Applicant: SZ DJI TECHNOLOGY CO., LTD., Shenzhen (CN)

(72) Inventors: Liefeng LIU, Shenzhen (CN); Mingli CUI, Shenzhen (CN); Yong CONG, Shenzhen (CN)

(21) Appl. No.: 17/018,868

(22) Filed: Sep. 11, 2020

Related U.S. Application Data
(63) Continuation of application No. PCT/CN2018/078946, filed on Mar. 14, 2018.

(51) Int. Cl. G05D 1/10; B64C 39/02

(52) U.S. Cl. CPC G05D 1/104; B64C 2201/143; B64C 39/024

(57) ABSTRACT

An unmanned aerial vehicle (UAV) control method includes generating a flight strategy for a target UAV in a UAV group, sending flight information to the target UAV, performing a clock synchronization on the target UAV to configure a reference time for the target UAV, and sending a take-off instruction to the target UAV. The flight strategy includes a flight instruction instructing the target UAV to fly to a target position at a target moment. The flight information includes the flight strategy. The take-off instruction triggers the target UAV to fly to the target position at the target moment according to the flight instruction by using the reference time as a standard reference time.

### CROSS-REFERENCE TO RELATED APPLICATION

This application is a continuation of International Application No. PCT/CN2018/078946, filed on Mar. 14, 2018, the entire content of which is incorporated herein by reference.

### TECHNICAL FIELD

The present disclosure relates to the technical field of control and, more particularly, to an unmanned aerial vehicle (UAV) control method and device, a UAV, a system, and a storage medium.

### BACKGROUND

With the development of computer technology, mobile devices such as unmanned aerial vehicles (UAVs), unmanned vehicles, robots that can realize autonomous movement, and the like, are becoming more and more widely used. Takes the UAVs as an example, the UAVs can be used for rapid preview of terrain, post-disaster emergency assessment, geographic mapping assistance, urban planning, and the like, and can also be used in agricultural plant protection, e.g., pesticide spraying, film and television shooting, e.g., video material stitching, and other large-scale industry application areas.

Currently, in order to improve an efficiency of the UAVs to complete tasks in the application fields described above, a UAV group is commonly used to perform the tasks. However, as the number of UAVs in the UAV group increases, it is becoming more and more difficult to control the UAVs in the UAV group. Therefore, how to control the UAVs in the UAV group more effectively becomes a focus of research.

### SUMMARY

In accordance with the disclosure, there is provided an unmanned aerial vehicle (UAV) control method including generating a flight strategy for a target UAV in a UAV group, sending flight information to the target UAV, performing a clock synchronization on the target UAV to configure a reference time for the target UAV, and sending a take-off instruction to the target UAV. The flight strategy includes a flight instruction instructing the target UAV to fly to a target position at a target moment. The flight information includes the flight strategy. The take-off instruction triggers the target UAV to fly to the target position at the target moment according to the flight instruction by using the reference time as a standard reference time.

Also in accordance with the disclosure, there is provided an unmanned aerial vehicle (UAV) control device including a memory storing program instructions and a processor configured to execute the program instructions to generate a flight strategy for a target UAV in a UAV group, send flight information to the target UAV, perform a clock synchronization on the target UAV to configure a reference time for the target UAV, and send a take-off instruction to the target UAV. The flight strategy includes a flight instruction instructing the target UAV to fly to a target position at a target moment. The flight information includes the flight strategy. The take-off instruction triggers the target UAV to fly to the target position at the target moment according to the flight instruction by using the reference time as a standard reference time

Also in accordance with the disclosure, there is provided an unmanned aerial vehicle (UAV) including a body, a power system arranged at the body and configured to provide a flight power for the UAV, and a processor configured to receive flight information including a flight strategy from a UAV control device, obtain a reference time configured by the UAV control device for the UAV, and, in response to a take-off instruction, control the UAV to fly to a target position at a target moment according to instruction of the flight strategy by using the reference time as a standard reference time.

### BRIEF DESCRIPTION OF THE DRAWINGS

In order to provide a clearer illustration of technical solutions of disclosed embodiments, the drawings used in the description of the disclosed embodiments are briefly described below. It will be appreciated that the disclosed drawings are merely examples and other drawings conceived by those having ordinary skills in the art on the basis of the described drawings without inventive efforts should fall within the scope of the present disclosure.

FIG. 1A is a schematic structural diagram of an unmanned aerial vehicle (UAV) control system consistent with embodiments of the disclosure.

FIG. 1B schematically shows controlling a UAV group consistent with embodiments of the disclosure.

FIG. 2 is a schematic flow chart of a UAV control method consistent with embodiments of the disclosure.

FIG. 3 is a schematic flow chart of another UAV control method consistent with embodiments of the disclosure.

FIG. 4 is a schematic structural diagram of a UAV control device consistent with embodiments of the disclosure.

### DETAILED DESCRIPTION OF THE EMBODIMENTS

In order to provide a clearer illustration of technical solutions of disclosed embodiments, example embodiments will be described with reference to the accompanying drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

Hereinafter, the example embodiments will be described with reference to the accompanying drawings. Unless conflicting, the exemplary embodiments and features in the exemplary embodiments can be combined with each other.

An unmanned aerial vehicle (UAV) control method consistent with the present disclosure can be performed by a UAV control device. The UAV control device can be arranged at a smart terminal that controls each UAV in a UAV group (e.g., a tablet computer, a mobile phone, a smart watch, or the like), or can be arranged at an unmanned flying device (e.g., the UAV), an unmanned vehicle, a robot, or any device that can realize the autonomous movement, which is not limited herein. Tasks that each UAV in the UAV group can perform through a control of the UAV control device can include one or more of a light show task, a large-scale real-time map reconstruction task, an agricultural plant protection task, a film and television shooting task, an autonomous flight along a certain trajectory, and the like, which is not limited herein. Hereinafter, the UAV control method corresponding to when the UAVs in the UAV group perform the tasks described above will be described. The UAV control method described below can also be applied to other devices, which is not limited herein.

Consistent with the disclosure, the UAV control device can control a coordinated flight and operation of various UAVs in the UAV group to achieve a fast and efficient completion of related tasks. During a process of achieving the coordinated operation of the UAVs in the UAV group, the UAV control device can generate a flight strategy for the UAVs in the UAV group. The flight strategy may include a flight instruction instructing the UAVs of the UAV group to fly to corresponding target positions at corresponding target moments. The UAV control device may send flight information to the UAVs in the UAV group, and the flight information can include the flight strategies generated for the UAVs in the UAV group. The UAV control device may perform a clock synchronization on the UAVs in the UAV group, configure a reference time for the UAVs, and send take-off instructions to various UAVs in the UAV group. In some embodiments, the take-off instructions can be used to trigger various UAVs to fly to the corresponding target positions at the corresponding target times according to the instructions of the flight strategies by using the reference time as a standard reference time.

In some embodiments, the UAV control device can obtain a group task of the UAV group, divide the group task into a plurality of sub-tasks, and plan the flight strategy for a target UAV in the UAV group according to the plurality of sub-tasks. The flight strategy can include the flight instruction instructing the target UAV to fly to the target position at the target moment. For example, assume that the group task of the UAV group obtained by the UAV control device is a light show task, the UAV control device may divide the light show task into the plurality of sub-tasks according to the number of UAVs in the UAV group, and allocate the plurality of sub-tasks to the various UAVs in the UAV group. The UAV control device may plan the flight strategy for the target UAV according to the corresponding sub-task.

In some embodiments, the flight strategy can include a control instruction indicating an attitude of the target UAV in the UAV group at the target moment and target position. The control instruction can be used to indicate an attitude angle of the target UAV in the UAV group at the target moment and the target position. The attitude angle can include an attitude angle of a gimbal of the target UAV in the UAV group, such that the target UAV can control the attitude angle of the gimbal of the target UAV in response to the control instruction during a flight of the target UAV. For example, the flight strategy can include the control instruction indicating the attitude of the target UAV at target time T1 and target position L1, and the control instruction can be used to indicate the attitude angle of the gimbal of the target UAV at target time T1 and target position L1 to be, for example, a pitch angle of 10°, a roll angle of 18°, and a yaw angle of 20°.

In some embodiments, the flight strategy can include an execution instruction indicating an action of a load of the target UAV in the UAV group at the target moment and target position. In some embodiments, the load of the target UAV can include an external device connected to the target UAV, for example, a light. The execution instruction of the action of the load of the target UAV at the target time and target position can be used to indicate an action attitude of the load of the target UAV at the target time and target position, such as an angle and orientation of the load. For example, assume that the load includes the light connected to the target UAV through the gimbal, and the flight strategy can include the execution instruction indicating the action of the light connected to the target UAV at target time T1 and target position L1. The execution instruction can be used to instruct the light connected to the target UAV to face north at an angle of 45° at target time T1 and target position L1.

In some embodiments, the load and the target UAV can be connected through the gimbal of the target UAV, such that the UAV control device can adjust the action attitude, e.g., a direction, angle, position, and the like, of the load by adjusting the gimbal. The load may also be connected to the target UAV through other connection manners, which is not limited herein.

In some embodiments, the UAV control device may send the flight information to a UAV in the UAV group, and the flight information can include a UAV identification (ID) of the UAV and the flight strategy, such that the UAV in the UAV group can obtain the flight strategy corresponding to the UAV ID. The UAV ID may include one or more of a UAV model, a number set by a user for the UAV, a UAV engine number, and the like, which is not limited herein.

In some embodiments, the UAV control device may determine the target UAV according to the UAV ID in the flight information, and send the flight strategy corresponding to the UAV ID to the target UAV in the UAV group. For example, assume that the UAV ID is 1, and the UAV control device may determine the flight strategy corresponding to UAV ID 1 according to the UAV ID in the flight information, and send the flight strategy to the target UAV.

In some embodiments, the UAV control device may perform a frequency synchronization on the UAVs in the UAV group. For example, the UAV control device can configure a reference frequency for the UAVs, such that the various UAVs in the UAV group can use the reference frequency as a standard reference frequency to achieve the frequency synchronization.

In some embodiments, the UAV control device may send the take-off instruction to various UAVs in the UAV group. The take-off instruction can be used to trigger the various UAVs to establish a communication frequency by using the reference frequency as the standard reference frequency, and to fly according to the flight instruction of the corresponding flight strategy, and hence, the various UAVs can use the reference frequency as the standard reference frequency. As such, the various UAVs in the UAV group can achieve the frequency synchronization, and thus, the various UAV in the UAV group can fly to the corresponding target positions at the corresponding target moments.

In some embodiments, the UAV control device may perform a clock synchronization on the UAVs in the UAV group, and configure the reference time for the UAVs, such that the UAVs in the UAV group can use the reference time as the standard reference time to achieve the clock synchronization.

In some embodiments, the UAV control device may send the take-off instruction to the various UAVs in the UAV group. The take-off instruction can be used to trigger the various UAVs to fly according to the instructions of the corresponding flight strategy by using the reference time as the standard reference time, and hence, the various UAVs in the UAV group can fly to the corresponding target positions at the corresponding target moments.

In some embodiments, the UAV control device can obtain data information of various UAVs in the UAV group during flight. The data information can include one or more of a flight direction, a flight position, and power information. An abnormal UAV having an abnormality can be determined from the UAV group according to the data information.

In some embodiments, the UAV control device can detect whether an abnormal UAV exists in the UAV group. An abnormal UAV can refer to a target UAV having the flight direction included in the data information of the target UAV inconsistent with the flight direction indicated by the flight strategy corresponding to the target UAV. If a detection result is that such a target UAV exists, the UAV control device may determine the target UAV as an abnormal UAV. For example, assume that the flight direction of the target UAV indicated by the flight strategy is north, if the UAV control device detects that the flight direction of the target UAV is south, the target UAV may be determined as an abnormal UAV.

In some embodiments, the UAV control device can detect whether any abnormal UAV exists in the UAV group. An abnormal UAV can refer to a target UAV having the flight position included in the data information of the target UAV inconsistent with the flight position indicated by the flight strategy corresponding to the target UAV. If the detection result is that such a target UAV exists, the UAV control device may determine the target UAV as an abnormal UAV. For example, assume that the flight position of the target UAV indicated by the flight strategy is L1, if the UAV control device detects that the flight position of the target UAV in the UAV group is L2, the target UAV may be determined as an abnormal UAV.

In some embodiments, the UAV control device can detect whether any abnormal UAV exists in the UAV group. An abnormal UAV can refer to a target UAV having the power information included in the data information of the target UAV less than a preset power threshold. If the detection result is that such a target UAV exists, the UAV control device may determine the target UAV as an abnormal UAV. For example, assume that the UAV control device obtains that the power of the target UAV in the UAV group during flight is less than the preset power threshold, the target UAV may be determined as an abnormal UAV.

In some embodiments, if an abnormal UAV is determined in the UAV group, the UAV control device may send a returning control instruction to the abnormal UAV. The returning control instruction can be used to instruct the abnormal UAV to return to a take-off position of the abnormal UAV, so as to resolve the abnormality of the abnormal UAV.

Hereinafter, the UAV control method consistent with the disclosure will be described with reference to the accompany drawings.

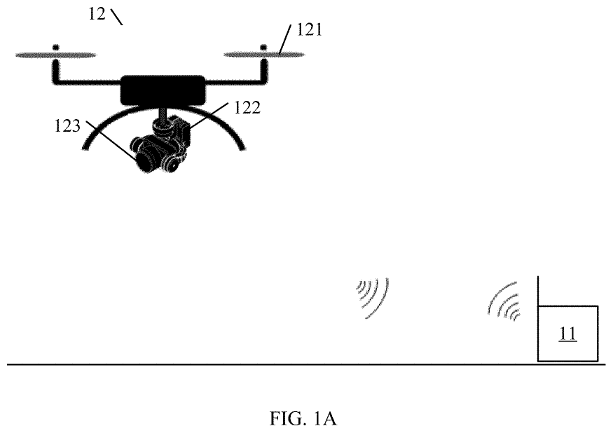

The UAV control method consistent with the present disclosure may be implemented by a UAV control system including a UAV control device and a UAV. FIG. 1A is a schematic structural diagram of an example UAV control system consistent with the disclosure. As shown in FIG. 1A, the UAV control system includes a UAV control device 11 and a UAV 12. The UAV control device 11 may include a control terminal of the UAV 12, for example, one or more of a remote controller, a smartphone, a tablet computer, a laptop computer, a ground station, and a wearable device (e.g., a watch or a wristband). The UAV 12 may include a rotary-wing UAV, such as a four-rotor UAV, a six-rotor UAV, an eight-rotor UAV, or the like, or a fixed-wing UAV. The UAV 12 includes a power system 121 configured to provide a flight power for the UAV 12. The power system 121 can include one or more of a propeller, a motor, and an electronic speed control (ESC). The UAV 12 further includes a gimbal 122 and a shooting device 123, and the shooting device 123 can be mounted at a body of the UAV 12 through the gimbal 122. The shooting device 123 can be configured to shoot images or videos during a flight of the UAV 12, and include, but not limited to, a multi-spectral imager, a hyper-spectral imager, a visible light camera, an infrared camera, and the like. The gimbal 122 can include a multi-axis transmission and stabilization system. A motor of the gimbal 122 can compensate a shooting angle of the shooting device 123 by adjusting a rotation angle about a rotation axis of the gimbal 122, and prevent or reduce a jitter of the shooting device 123 by arranging an appropriate buffer mechanism.

In some embodiments, the UAV control device 11 can generate the flight strategy for the UAV 12. The flight strategy may include the flight instruction instructing the UAV 12 to fly to the target position at the target moment. The UAV control device 11 may send the flight information to the UAV 12, and the flight information can include the flight strategy generated for the UAV 12. The UAV control device 11 may perform the clock synchronization on the UAV 12, configure the reference time for the UAV 12, and send the take-off instruction to the UAV 12. The take-off instruction can be used to trigger the UAV 12 to fly to the target position at the target time according to the instruction of the flight strategy by using the reference time as the standard reference time.

In some embodiments, the UAV group may include a plurality of UAVs, and the number of UAVs in the UAV group is not limited herein.

FIG. 1B schematically shows controlling the UAV group consistent with the disclosure. FIG. 1b shows a user 10, the UAV control device 11, a first UAV 12, and a second UAV 13. The first UAV 12 includes the power system 121, the gimbal 122, and the shooting device 123, and is described above in connection with FIG. 1A, and detailed description thereof is omitted herein. The second UAV 13 includes a power system 131, a gimbal 132, and a shooting device 133A. A structure of the second UAV 13 is similar to that of the first UAV 12, and detailed description thereof is omitted herein.

In some embodiments, the user 10 can generate the flight strategies for the first UAV 12 and the second UAV 13 via the UAV control device 11. The flight strategies may include the flight instructions instructing the first UAV 12 and the second UAV 13 to fly to their target positions at their target moments. The UAV control device 11 may send the flight information to the first UAV 12 and the second UAV 13 of the UAV group, and the flight information can include the generated flight strategies. The UAV control device 11 may perform the clock synchronization on the first UAV 12 and the second UAV 13 of the UAV group, configure the reference time for the first UAV 12 and the second UAV 13, and send the take-off instructions to the first UAV 12 and the second UAV 13. The take-off instructions can be used to trigger the first UAV 12 and the second UAV 13 to fly to their target positions at their target times according to the flight instructions of the flight strategies by using the reference time as the standard reference time. The implementation on each UAV in the UAV group will be described below.

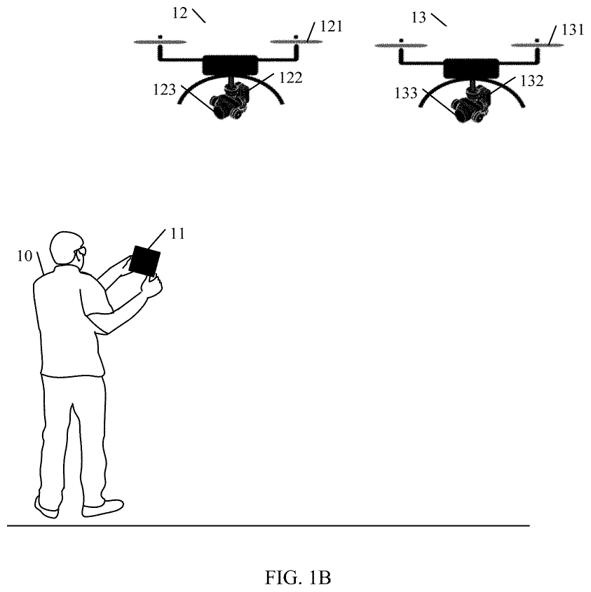

FIG. 2 is a schematic flow chart of an example UAV control method consistent with the disclosure. The method may be performed by a UAV control device arranged at a smart terminal or a flying device. Detailed descriptions of the UAV control device can be omitted and references can be made to the description of the UAV control device 11 in FIGS. 1A and 1B.

As shown in FIG. 2, at S201, the flight strategy for the target UAV in the UAV group is generated. The UAV control device can generate the flight strategy for the target UAV in the UAV group. The UAV group can include one or more UAVs. The target UAV can be any UAV in the UAV group, and there can be one or more target UAVs in the UAV group. The number of target UAVs can be equal to or less than the number of UAVs in the UAV group. The flight strategy may include the flight instruction instructing the target UAV of the UAV group to fly to the target position at the target moment. For example, the flight instruction can instruct the target UAV to arrive at the target position at the target moment. In some embodiments, the flight strategy can include the control instruction indicating the attitude of the target UAV in the UAV group at the target moment and target position. In some embodiments, the flight strategy can include the execution instruction indicating the action of the load of the target UAV in the UAV group at the target moment and target position. In some embodiments, the load of the target UAV can include the external device connected to the target UAV, for example, a light.

In some embodiments, the UAV control device can obtain the group task of the UAV group, divide the group task into the plurality of sub-tasks, and plan the flight strategy for the target UAV in the UAV group according to a sub-task. In some embodiments, the UAV control device may obtain the group task of the UAV group through a user operation or another manner, which is not limited herein. For example, assume that the group task of the UAV group obtained by the UAV control device is the light show task, the UAV control device may divide the light show task into the plurality of sub-tasks according to the number of UAVs in the UAV group, and allocate the plurality of sub-tasks to various UAVs in the UAV group. The UAV control device may plan the flight strategy for the target UAV according to the corresponding sub-task.

In some embodiments, the flight strategy can include the control instruction indicating the attitude of the target UAV in the UAV group at the target moment and target position. The control instruction can be used to indicate the attitude angle of the UAV in the UAV group at the target moment and the target position. The attitude angle can include the attitude angle of the gimbal of the target UAV in the UAV group, such that the target UAV can control the attitude angle of the gimbal of the target UAV in response to the control instruction during the flight of the target UAV. For example, the flight strategy can include the control instruction indicating the attitude of the target UAV at target time T1 and target position L1, and the control instruction can be used to instruct the attitude angle of the gimbal of the target UAV at target time T1 and target position L1 to be, for example, the pitch angle of 10°, the roll angle of 18°, and the yaw angle of 20°.

In some embodiments, the flight strategy can include the execution instruction indicating the action of the load of the target UAV in the UAV group at the target moment and target position. In some embodiments, the load of the target UAV can include the external device connected to the target UAV, for example, a light. The execution instruction of the action of the load of the target UAV at the target time and target position can be used to indicate the action attitude of the load of the target UAV at the target time and target position, such as the angle and orientation of the load. For example, assume that the load includes the light connected to the target UAV through the gimbal, and the flight strategy can include the execution instruction indicating the action of the light connected to the target UAV at target time T1 and target position L1. The execution instruction can be used to instruct the light connected to the target UAV to face north at the angle of 45° at target time T1 and target position L1.

In some embodiments, the load and the target UAV can be connected through the gimbal of the target UAV, such that the UAV control device can adjust the action attitude, e.g., the direction, angle, position, and the like, of the load by adjusting the gimbal. The load may also be connected to the target UAV through other connection manners, which is not limited herein.

At S202, the flight information is sent to the target UAV in the UAV group. The UAV control device may send the flight information to the target UAV in the UAV group, and the flight information can include the UAV ID of the target UAV and the flight strategy, such that the target UAV in the UAV group can obtain the flight strategy corresponding to the UAV ID. The UAV ID may include one or more of the UAV model, the number set by the user for the UAV, the UAV engine number, and the like, which is not limited herein.

In some embodiments, the UAV control device may determine the target UAV according to the UAV ID in the flight information, and send the flight strategy corresponding to the UAV ID to the target UAV in the UAV group. For example, assume that the UAV ID is 1, and the UAV control device may determine the flight strategy corresponding to UAV ID 1 according to the UAV ID in the flight information, and send the flight strategy to the target UAV.

At S203, the clock synchronization is performed on the target UAV in the UAV group to configure the reference time for the target UAV. In some embodiments, performing clock synchronization on the target UAV includes synchronizing the clocks of various UAVs in the UAV group including the target UAV. In some embodiments, the UAV control device may perform the clock synchronization on the target UAV in the UAV group and configure the reference time for the target UAV, such that the target UAV in the UAV group can use the reference time as the standard reference time to achieve the clock synchronization.

In some embodiments, the UAV control device may perform the frequency synchronization on the target UAV in the UAV group, and configure the reference frequency for the target UAV, such that the target UAV in the UAV group can use the reference frequency as the standard reference frequency to achieve the frequency synchronization. In some embodiments, performing the frequency synchronization on the target UAV includes synchronizing frequencies of various UAVs in the UAV group including the target UAV.

At S204, the take-off instruction is sent to the target UAV in the UAV group. In some embodiments, the UAV control device can send the take-off instruction to the target UAV in the UAV group. The take-off instruction can be used to trigger the target UAV to fly according to the flight instruction of the flight strategy by using the reference time as the standard reference time, and hence, the target UAV in the UAV group can fly to the target position at the target moment.

In some embodiments, the UAV control device may send the take-off instruction to the target UAV in the UAV group. The take-off instruction can be used to trigger the target UAV to establish the communication frequency by using the reference frequency as the standard reference frequency, and to fly according to the flight instruction of the flight strategy, such that the target UAV can use the reference frequency as the standard reference frequency. As such, the target UAV in the UAV group can achieve the frequency synchronization, and hence, the target UAV in the UAV group can fly to the target position at the target moment.

Consistent with the disclosure, the UAV control device can generate the flight strategy for the target UAV in the UAV group and send the flight information to the target UAV in the UAV group. The flight information can include the generated flight strategy. The UAV control device can perform the clock synchronization on the target UAV in the UAV group, configure the reference time for the target UAV, and send the take-off instruction to the target UAV in the UAV group. The take-off instruction can be used to trigger the target UAV to fly according to the flight instruction of the flight strategy by using the reference time as the standard reference time, such that the target UAV can fly to the target position at the target moment. As such, the coordinated operation of the UAVs in the UAV group can be realized, and the efficiency of the UAV group to perform tasks can be improved.

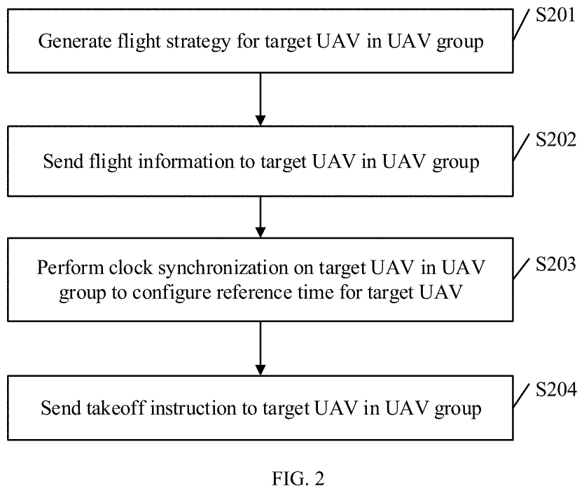

FIG. 3 is a schematic flow chart of another example UAV control method consistent with the disclosure. The method may be performed by a UAV control device. Detailed descriptions of the UAV control device is omitted and reference can be made to the description of the UAV control device 11 in connection with FIGS. 1A and 1B. Different from method in FIG. 2, the method in FIG. 3 can obtain the data information of various UAVs in the UAV group during flight, determine the abnormal UAV from the UAV group, and send the returning control instruction to the abnormal UAV to return the abnormal UAV to the take-off position of the abnormal UAV, so as to resolve the abnormality of the abnormal UAV.

As shown in FIG. 3, at S301, the data information of the various UAVs in the UAV group during the flight is obtained. After the UAV control device sends the take-off instructions to the various UAVs in the UAV group, the take-off instructions can trigger the various UAVs to fly according to the flight instructions of the corresponding flight strategies by using the reference time as the standard reference time. The UAV control device can obtain the data information of the various UAVs in the UAV group during flight. The data information can include one or more of the flight direction, the flight position, and the power information, which is not limited herein.

At S302, the abnormal UAV having abnormality is determined from the UAV group according to the data information. The abnormal UAV having abnormality can be determined from the UAV group according to the data information. In some embodiments, the UAV control device may detect whether the data information is consistent with the data information corresponding to the flight strategy generated for a UAV in the UAV group according to the obtained data information of the UAV in the UAV group. If it is inconsistent, the UAV having the inconsistent data information can be determined as the abnormal UAV. The data information can include one or more of the flight direction, the flight position, and the power information, which is not limited herein.

In some embodiments, the UAV control device can detect whether an abnormal UAV exists in the UAV group. An abnormal UAV can refer to a UAV having the flight direction included in the data information of the target UAV inconsistent with the flight direction indicated by the flight strategy corresponding to the UAV. If the UAV control device detects that there is a UAV in the UAV group whose flight direction is inconsistent with the flight direction indicated by the flight strategy corresponding to the UAV, the UAV can be determined as an abnormal UAV. For example, assume that the flight direction of a UAV indicated by the flight strategy is north, if the UAV control device detects that the flight direction of the UAV is south, the UAV can be determined as an abnormal UAV.

In some embodiments, the UAV control device can detect whether an abnormal UAV exists in the UAV group. An abnormal UAV can refer to that a UAV having the flight position included in the data information of the UAV inconsistent with the flight position indicated by the flight strategy corresponding to the UAV. If the UAV control device detects that there is a UAV in the UAV group whose flight position is inconsistent with the flight position indicated by the flight strategy corresponding to the UAV, the UAV may be determined as an abnormal UAV. For example, assume that the flight position of a UAV indicated by the flight strategy is L1, if the UAV control device detects that the flight position of the UAV in the UAV group is L2, the UAV can be determined as an abnormal UAV.

In some embodiments, the UAV control device can detect whether an abnormal UAV exists in the UAV group. An abnormal UAV can refer to a UAV having the power information included in the data information of the UAV less than the preset power threshold. If the UAV control device detects that there is a UAV in the UAV group whose power information is less than the preset power threshold, the UAV may be determined as an abnormal UAV. For example, assume that the UAV control device obtains that the power of a UAV in the UAV group during flight is less than the preset power threshold, the UAV can be determined as an abnormal UAV.

At S303, the returning control instruction is sent to the abnormal UAV. If the abnormal UAV is determined in the UAV group, the UAV control device may send the returning control instruction to the abnormal UAV. The returning control instruction can be used to instruct the abnormal UAV to return to the take-off position of the abnormal UAV, so as to resolve the abnormality of the abnormal UAV. For example, assume that the UAV control device determines that the abnormality of the abnormal UAV is that the power is lower than the preset power threshold of 10%, the UAV control device may send the returning control instruction to the abnormal UAV. As such, the abnormal UAV can return to the take-off position, and hence, the user can charge the abnormal UAV to resolve the abnormality of the abnormal UAV.

Consistent with the disclosure, the UAV control device can obtain the data information of various UAVs in the UAV group during flight, determine the abnormal UAV having abnormality from the UAV group according to the data information, and send the returning control instruction to the abnormal UAV. As such, the abnormal UAV can return to the take-off position to resolve the abnormality of the abnormal UAV, thereby improving a safety of the flight of the UAV group.

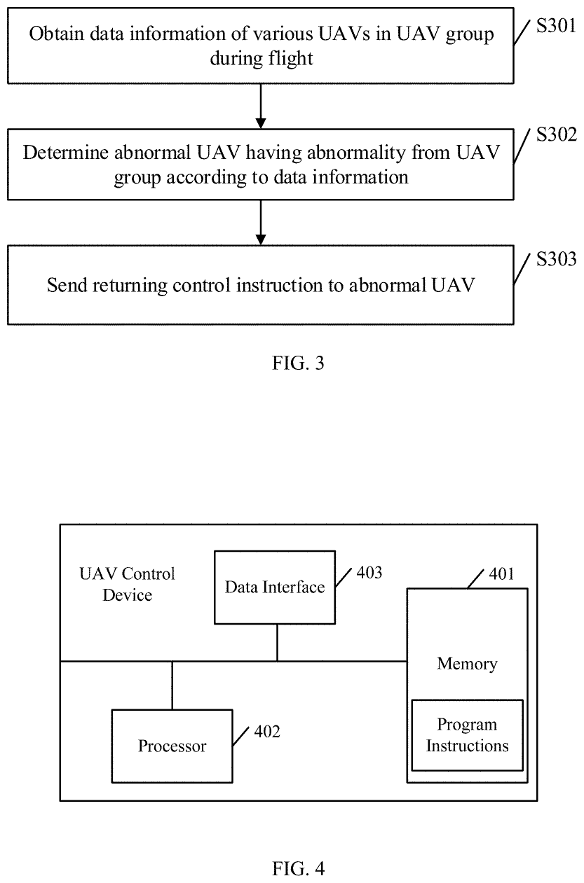

FIG. 4 is a schematic structural diagram of an example UAV control device consistent with the disclosure. As shown in FIG. 4, the UAV control device includes a memory 401, a processor 402, and a data interface 403.

The memory 401 may include a volatile memory, a non-volatile memory, or any combination of thereof. The processor 402 may include a central processing unit (CPU). The processor 402 may include a hardware chip. The hardware chip may include an application-specific integrated circuit (ASIC), a programmable logic device (PLD), or any combination thereof. For example, the hardware ship may include a complex programmable logic device (CPLD), a field-programmable gate array (FPGA), or any combination thereof.

The memory 401 can be configured to store program instructions. The processor 402 can call the program instructions stored in the memory 401 to generate the flight strategy for the target UAV in the UAV group where the flight strategy may include the flight instruction instructing the target UAV of the UAV group to fly to the target position at the target moment, send the flight information to the target UAV in the UAV group where the flight information can include the flight strategy, perform the clock synchronization on the target UAV in the UAV group to configure the reference time for the target UAV, and send the take-off instruction to the target UAV in the UAV group. The take-off instruction can be used to trigger the target UAV to fly to the target position at the target moment according to the flight instruction of the flight strategy by using the reference time as the standard reference time.

The processor 402 can further call the program instructions stored in the memory 401 to obtain the group task of the UAV group where the group task can be divided into the plurality of sub-tasks, and plan the flight strategy for the target UAV in the UAV group according to the corresponding sub-task. The flight strategy may include the flight instruction instructing the target UAV to fly to the target position at the target moment.

In some embodiments, the flight strategy can include the control instruction indicating the attitude of the target UAV at the target moment and target position. In some embodiments, the flight strategy can include the execution instruction indicating the action of the load of the target UAV at the target moment and target position.

The processor 402 can further call the program instructions stored in the memory 401 to send the flight information to the target UAV in the UAV group, where the flight information can include the UAV ID of the target UAV and the flight strategy, such that the target UAV in the UAV group can obtain the flight strategy corresponding to the UAV ID.

The processor 402 can further call the program instructions stored in the memory 401 to determine the target UAV according to the UAV ID in the flight information, and send the flight strategy corresponding to the UAV ID to the target UAV in the UAV group.

The processor 402 can further call the program instructions stored in the memory 401 to perform the frequency synchronization on the target UAV in the UAV group, and configure the reference frequency for the target UAV.

The processor 402 can further call the program instructions stored in the memory 401 to send the take-off instruction to the target UAV in the UAV group. The take-off instruction can be used to trigger the target UAV to establish the communication frequency by using the reference frequency as the standard reference frequency, and to fly to the target position at the target moment according to the flight instruction of the flight strategy.

The processor 402 can further call the program instructions stored in the memory 401 to obtain the data information of various UAVs in the UAV group during the flight where the data information can include one or more of the flight direction, the flight position, and the power information, and determine the abnormal UAV having abnormality from the UAV group according to the data information.

The processor 402 can further call the program instructions stored in the memory 401 to detect whether the abnormal UAV exists in the UAV group. An abnormal UAV can refer to a target UAV having the flight direction included in the data information of the target UAV inconsistent with the flight direction indicated by the flight strategy corresponding to the target UAV. Such a target UAV can be determined to be the abnormal UAV.

The processor 402 can further call the program instructions stored in the memory 401 to detect whether the abnormal UAV exists in the UAV group. An abnormal UAV can refer to a target UAV having the flight position included in the data information of the target UAV inconsistent with the flight position indicated by the flight strategy corresponding to the target UAV. Such a target UAV can be determined to be the abnormal UAV.

The processor 402 can further call the program instructions stored in the memory 401 to detect whether the abnormal UAV exists in the UAV group. An abnormal UAV can refer to a target UAV having the power information included in the data information of the target UAV less than the preset power threshold. Such a target UAV can be determined to be the abnormal UAV.

The processor 402 can further call the program instructions stored in the memory 401 to, if the abnormal UAV is determined in the UAV group, send the returning control instruction to the abnormal UAV. The returning control instruction can be used to instruct the abnormal UAV to return to the take-off position of the abnormal UAV.

Consistent with the disclosure, the UAV control device can generate the flight strategy for the target UAV in the UAV group and send the flight information to the target UAV in the UAV group. The flight information can include the generated flight strategy. The UAV control device can perform the clock synchronization on the target UAV in the UAV group, configure the reference time for the target UAV, and send the take-off instruction to the target UAV in the UAV group. The take-off instruction can be used to trigger the target UAV to fly according to the flight instruction of the flight strategy by using the reference time as the standard reference time, such that the target UAV can fly to the target position at the target moment. As such, the coordinated operation of the UAVs in the UAV group can be realized, and the efficiency of the UAV group to perform tasks can be improved.

The present disclosure also provides a UAV including a body, a power system arranged at the body and configured to provide the flight power, and a processor. The processor can be configured to receive the flight information sent by the UAV control device. The flight information can include the flight strategy generated for the UAV. The processor can be further configured to obtain the reference time configured, by the UAV control device, for the UAV, and in response to the take-off instruction sent by the UAV control device, control the UAV to fly to the target position at the target moment according to the flight instruction of the flight strategy by using the reference time as the standard reference time.

The UAV may include a four-rotor UAV, a six-rotor UAV, a multi-rotor UAV, or the like. The power system may include structures such as a motor, an ESC, a propeller, and the like. The motor can be configured to drive the propeller of the UAV, and the ESC can be configured to control a speed of the motor of the UAV.

The present disclosure also provides a UAV control system including a UAV control device and one or more UAVs.

The UAV control device can be configured to generate the flight strategy for the target UAV in the UAV group where the flight strategy may include the flight instruction instructing the target UAV of the UAV group to fly to the target position at the target moment, send the flight information to the target UAV in the UAV group where the flight information can include the flight strategy, perform the clock synchronization on the target UAV in the UAV group to configure the reference time for the target UAV, and send the take-off instruction to the target UAV in the UAV group. The take-off instruction can be used to trigger the target UAV to fly to the target position at the target moment according to the flight instruction of the flight strategy by using the reference time as the standard reference time.

Each of the one or more UAVs can be configured to receive the flight information sent by the UAV control device. The flight information can include the flight strategy generated for the UAV. Each of the one or more UAVs can be further configured to obtain the reference time configured, by the UAV control device, for the UAV, and in response to the take-off instruction sent by the UAV control device, control the UAV to fly to the target position at the target moment according to the flight instruction of the flight strategy by using the reference time as the standard reference time.

The UAV control device can be further configured to obtain the group task of the UAV group, divide the group task into the plurality of sub-tasks, and plan the flight strategy for the target UAV in the UAV group according to the corresponding sub-task. The flight strategy may include the flight instruction instructing the target UAV to fly to the target position at the target moment.

In some embodiments, the flight strategy can include the control instruction indicating the attitude of the target UAV at the target moment and target position. In some embodiments, the flight strategy can include the execution instruction indicating the action of the load of the target UAV at the target moment and target position.

The UAV control device can be further configured to send the flight information to the target UAV in the UAV group. The flight information can include the UAV ID of the target UAV and the flight strategy, such that the target UAV in the UAV group can obtain the flight strategy corresponding to the UAV ID.

The UAV control device can be further configured to determine the target UAV according to the UAV ID in the flight information, and send the flight strategy corresponding to the UAV ID to the target UAV in the UAV group.

The UAV control device can be further configured to perform the frequency synchronization on the target UAV in the UAV group, and configure the reference frequency for the target UAV.

The UAV control device can be further configured to send the take-off instruction to the target UAV in the UAV group. The take-off instruction can be used to trigger the target UAV to establish the communication frequency with the reference frequency as the standard reference frequency, and to fly to the target position at the target moment according to the flight instruction of the flight strategy.

The UAV control device can be further configured to obtain the data information of various UAVs in the UAV group during the flight. The data information can include one or more of the flight direction, the flight position, and the power information. The UAV control device can be further configured to determine the abnormal UAV having abnormality from the UAV group according to the data information.

The UAV control device can be further configured to detect whether the abnormal UAV exists in the UAV group. An abnormal UAV can refer to a target UAV having the flight direction included in the data information of the target UAV inconsistent with the flight direction indicated by the flight strategy corresponding to the target UAV. Such a target UAV can be determined to be the abnormal UAV.

The UAV control device can be further configured to detect whether the abnormal UAV exists in the UAV group. An abnormal UAV can refer to a target UAV having the flight position included in the data information of the target UAV inconsistent with the flight position indicated by the flight strategy corresponding to the target UAV. Such a target UAV can be determined to be the abnormal UAV.

The UAV control device can be further configured to detect whether the abnormal UAV exists in the UAV group. The abnormal UAV can refer to a target UAV having the power information included in the data information of the target UAV less than the preset power threshold. Such a target UAV can be determined to be the abnormal UAV.

The UAV control device can be further configured, if the abnormal UAV is determined in the UAV group, to send the returning control instruction to the abnormal UAV. The returning control instruction can be used to instruct the abnormal UAV to return to the take-off position of the abnormal UAV.

Consistent with the disclosure, the UAV control device can generate the flight strategy for the target UAV in the UAV group and send the flight information to the target UAV in the UAV group. The flight information can include the generated flight strategy. The UAV control device can perform the clock synchronization on the target UAV in the UAV group, configure the reference time for the target UAV, and send the take-off instruction to the target UAV in the UAV group. The take-off instruction can be used to trigger the target UAV to fly according to the flight instruction of the flight strategy by using the reference time as the standard reference time, such that the target UAV can fly to the target position at the target moment. As such, the coordinated operation of the UAVs in the UAV group can be realized, and the efficiency of the UAV group to perform tasks can be improved.

The present disclosure also provides a computer-readable storage medium storing a computer program. When the computer program is executed by the processor, the UAV control method in FIG. 2 or FIG. 3 may be implemented, and the UAV control device in FIG. 4 may be implemented, and detailed description thereof is omitted herein.

The computer-readable storage medium may include an internal storage unit of the device consistent with the disclosure, such as a hard disk or a memory of the device. The computer-readable storage medium may further include an external storage device of the device, such as a plug-in hard disk, a smart memory card (SMC), a secure digital (SD) card, a flash card, and any storage medium arranged at the device. The computer-readable storage medium may further include both the internal storage unit of the device and the external storage device. The computer-readable storage medium can be configured to store the computer program and other programs and data required by the terminal. The computer-readable storage medium can be further configured to temporarily store data that has been or will be output.

Some or all of the processes of the method described above can be executed by hardware running program instructions. The program may be stored in a computer-readable storage medium. When the program is executed, one or any combination of the processes of the method are executed. The computer-readable storage medium can include a magnetic disk, an optical disk, a read-only memory (ROM) or a random access memory (RAM), or the like.

It is intended that the disclosed embodiments be considered as exemplary only and not to limit the scope of the disclosure. Changes, modifications, alterations, and variations of the above-described embodiments may be made by those skilled in the art within the scope of the disclosure.

What is claimed is:

1. An unmanned aerial vehicle (UAV) control method comprising:
generating a flight strategy for a target UAV in a UAV group, the flight strategy including a flight instruction instructing the target UAV to fly to a target position at a target moment;
sending flight information to the target UAV, the flight information including the flight strategy;
performing a clock synchronization on the target UAV to configure a reference time for the target UAV; and
sending a take-off instruction to the target UAV, the take-off instruction triggering the target UAV to fly to the target position at the target moment according to the flight instruction by using the reference time as a standard reference time.

2. The method of claim 1, wherein generating the flight strategy for the target UAV includes:
obtaining a group task of the UAV group;
dividing the group task into a plurality of sub-tasks; and
planning the flight strategy for the target UAV according to a corresponding one of the plurality of sub-tasks.

3. The method of claim 2, wherein the flight strategy includes at least one of:
a control instruction indicating an attitude of the target UAV at the target moment and target position; or
an execution instruction indicating an action of a load of the target UAV at the target moment and target position.

4. The method of claim 1, wherein the flight information further includes a UAV identification (ID) of the target UAV.

5. The method of claim 4, wherein sending the flight information to the target UAV includes:
determining the target UAV according to the UAV ID in the flight information; and
sending the flight strategy corresponding to the UAV ID to the target UAV.

6. The method of claim 1, further comprising:
performing a frequency synchronization on the target UAV in the UAV group; and
configuring a reference frequency for the target UAV.

7. The method of claim 6, wherein the take-off instruction is further configured to trigger the target UAV to establish a communication frequency by using the reference frequency as a standard reference frequency.

8. The method of claim 1, further comprising:
obtaining data information of the target UAV during a flight of the target UAV, the data information including one or more of a flight direction, a flight position, and power information; and
determining whether the target UAV is an abnormal UAV having abnormality according to the data information.

9. The method of claim 8, further comprising:
sending a returning control instruction to the target UAV in response to determining that the target UAV is the abnormal UAV, the returning control instruction instructing the target UAV to return to a take-off position of the target UAV.

10. An unmanned aerial vehicle (UAV) control device comprising:
a memory storing program instructions; and
a processor configured to execute the program instructions stored in the memory to:
generate a flight strategy for a target UAV in a UAV group, the flight strategy including a flight instruction instructing the target UAV to fly to a target position at a target moment;
send flight information to the target UAV, the flight information including the flight strategy;
perform a clock synchronization on the target UAV to configure a reference time for the target UAV; and
send a take-off instruction to the target UAV, the take-off instruction triggering the target UAV to fly to the target position at the target moment according to the flight instruction by using the reference time as a standard reference time.

11. The device of claim 10, wherein the processor is further configured to execute the program instructions to:
obtain a group task of the UAV group;
divide the group task into a plurality of sub-tasks; and
plan the flight strategy for the target UAV according to a corresponding one of the plurality of sub-tasks.

12. The device of claim 11, wherein the flight strategy includes at least one of:
a control instruction indicating an attitude of the target UAV at the target moment and target position; or
an execution instruction indicating an action of a load of the target UAV at the target moment and target position.

13. The device of claim 10, wherein the flight information further includes a UAV identification (ID) of the target UAV.

14. The device of claim 13, wherein the processor is further configured to execute the program instructions to:
determine the target UAV according to the UAV ID; and
send the flight strategy corresponding to the UAV ID to the target UAV.

15. The device of claim 10, wherein the processor is further configured to execute the program instructions to:
perform a frequency synchronization on the target UAV; and
configure a reference frequency for the target UAV.

16. The device of claim 15, wherein the take-off instruction is further configured to trigger the target UAV to establish a communication frequency by using the reference frequency as a standard reference frequency.

17. The device of claim 10, wherein the processor is further configured to execute the program instructions to:
obtain data information of the target UAV during a flight of the target UAV, the data information including one or more of a flight direction, a flight position, and power information; and
determine whether the target UAV is an abnormal UAV according to the data information.

18. The device of claim 17, wherein the processor is further configured to execute the program instructions to:
send a returning control instruction to the target UAV in response to determining that the target UAV is the abnormal UAV, the returning control instruction instructing the target UAV to return to a take-off position of the target UAV.

19. An unmanned aerial vehicle (UAV) comprising:
a body;
a power system arranged at the body and configured to provide a flight power for the UAV; and
a processor configured to:
receive flight information from a UAV control device, the flight information including a flight strategy generated for the UAV;
obtain a reference time configured by the UAV control device for the UAV;
in response to a take-off instruction, control the UAV to fly to a target position at a target moment according to instruction of the flight strategy by using the reference time as a standard reference time.
